(19) United States
(12) Patent Application Publication
(10) Pub. No.: US 2012/0147154 A1
(43) Pub. Date: Jun. 14, 2012

(54) Stereoscopic Video Display Apparatus and Method Therefor

(76) Inventor: Shinzo Matsubara, Akishima-shi (JP)

(21) Appl. No.: 13/183,239

(22) Filed: Jul. 14, 2011

(30) Foreign Application Priority Data
Dec. 14, 2010 (JP) 2010-278069

(51) Int. Cl. H04N 13/04

(52) U.S. Cl. 348/51; 348/E13.075

(57) ABSTRACT

According to one embodiment, a stereoscopic video display apparatus of a glasses-less type displays video that is perceived as original stereoscopic video when observed from the predetermined range of the viewing position and as defective stereoscopic video when observed from a position different from the predetermined range of the viewing position. A 3D related controller may insert an information signal that displays a figure, character, mark, or symbol indicating that the viewing position is different from the predetermined range of the viewing position into a signal of the defective stereoscopic video.

### CROSS-REFERENCE TO RELATED APPLICATIONS

This application is based upon and claims the benefit of priority from Japanese Patent Application No. 2010-278069, filed Dec. 14, 2010; the entire contents of which are incorporated herein by reference.

### FIELD

Embodiments described herein relate generally to a stereoscopic video display apparatus and a method therefor.

### BACKGROUND

Stereoscopic video display technology of a glasses-less type capable of perceiving stereoscopic video without using special glasses can be classified in various ways. Such stereoscopic video display technology is generally classified into a binocular parallax method using a binocular parallax and a spatial image reproducing method that actually forms a spatial image.

The binocular parallax method is further classified into a twin type and a multi type. The twin type is a method by which an image for the left eye and an image for the right eye are made visible by the left eye and the right eye, respectively. The multi type is a method by which a range in which stereoscopic video is observable is broadened by using a plurality of observation positions when a video is shot to increase the amount of information.

The spatial image reproducing method is further classified into a holograph method and an integral photography method (hereinafter, called the integral method, but may also be called a ray reproducing method). The integral method may be classified as the binocular parallax method. According to the integral method, rays take quite opposite paths between shooting and reproducing video and thus, almost complete stereoscopic video is reproduced if the number of rays is made sufficiently large and the pixel size can be made sufficiently small. Thus, the ideal integral method is classified as the spatial image reproducing method.

Incidentally, to perceive stereoscopic video without glasses as in the multi type and the integral method, the configuration described below is normally adopted. A stereoscopic video display pixel arrangement is configured on a two-dimensional image display pixel arrangement. A mask (also called a ray control element) having a function to control rays from stereoscopic video display pixels is arranged on a front face side of the stereoscopic video display pixel arrangement. The mask is provided with window portions far smaller than stereoscopic video display pixels (typically as small as two-dimensional image display pixels) in positions corresponding to stereoscopic video display pixels.

A fly eye lens in which micro-lenses are arranged two-dimensionally, a lenticular seat in a shape in which optical openings extend linearly in the vertical direction and are periodically arranged in the horizontal direction, or slits are used as the mask.

According to such a configuration, element images displayed by individual stereoscopic video display pixels are partially blocked by the mask so that an observer visually recognizes only element images that have passed through window portions. Therefore, two-dimensional image display pixels visually recognized via some window portion can be made different from observation position to observation position so that stereoscopic video can be perceived without glasses.

However, if this configuration is adopted, while original stereoscopic video, that is, true stereoscopic video is perceived when observed from the correct position, false (or defective) stereoscopic video is perceived when the observation position is shifted. This is because if the observation position is shifted, a portion of an element image displayed by an adjacent stereoscopic video display pixel is visually recognized from a window portion opposite to some stereoscopic video display pixel on a wide view angle side. In such a case, it is difficult for the observer to identify whether stereoscopic video being perceived is true stereoscopic video or false stereoscopic video.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing a representative outline of a stereoscopic video display apparatus according to an embodiment;

FIG. 2 is an exemplary view showing a representative relationship between the stereoscopic video display apparatus and observation positions and images perceived in each of observation positions;

FIG. 3 is an exemplary view showing a representative example in which a character string is displayed indicating that the observation position in which stereoscopic video is perceived is different from a predetermined range of the observation position;

FIG. 4 is an exemplary view showing another example in which the character string is displayed indicating that the observation position in which stereoscopic video is perceived is different from the predetermined range of the observation position;

FIGS. 5A and 5B are exemplary views showing a representative setting screen example when 3D related control settings of the stereoscopic video display apparatus are made;

FIG. 6 is an exemplary view showing a representative example of a display area of a 3D viewing position;

FIG. 7 is an exemplary view showing another setting screen example when 3D related control settings of the stereoscopic video display apparatus are made;

FIG. 8 is an exemplary view showing a representative example of a 3D processing module;

FIG. 9 is an exemplary view showing a representative overall configuration example of a TV set in which the stereoscopic video display apparatus is integrated; and

FIG. 10 is an exemplary view showing a representative relationship between the 3D processing module and a 3D related controller.

### DETAILED DESCRIPTION

Various embodiments will be described hereinafter with reference to the accompanying drawings.

In general, according to one embodiment, a stereoscopic video display apparatus and a method therefor capable of notifying a viewer of information video indicating that a viewing position is different from a predetermined range of the viewing position when the viewer observes 3D video from the viewing position different from the predetermined range of the viewing position in which the viewer can perceive true stereoscopic video.

According to the present disclosure, a stereoscopic video display apparatus of a glasses-less type displays video that is perceived as original stereoscopic video when observed from the predetermined range of the viewing position and as defective stereoscopic video when observed from a position different from the predetermined range of the viewing position. A 3D related controller inserts an information signal that displays a figure, character, mark, or symbol indicating that the viewing position is different from the predetermined range of the viewing position into a signal of the defective stereoscopic video.

An embodiment will further be described with reference to the drawings.

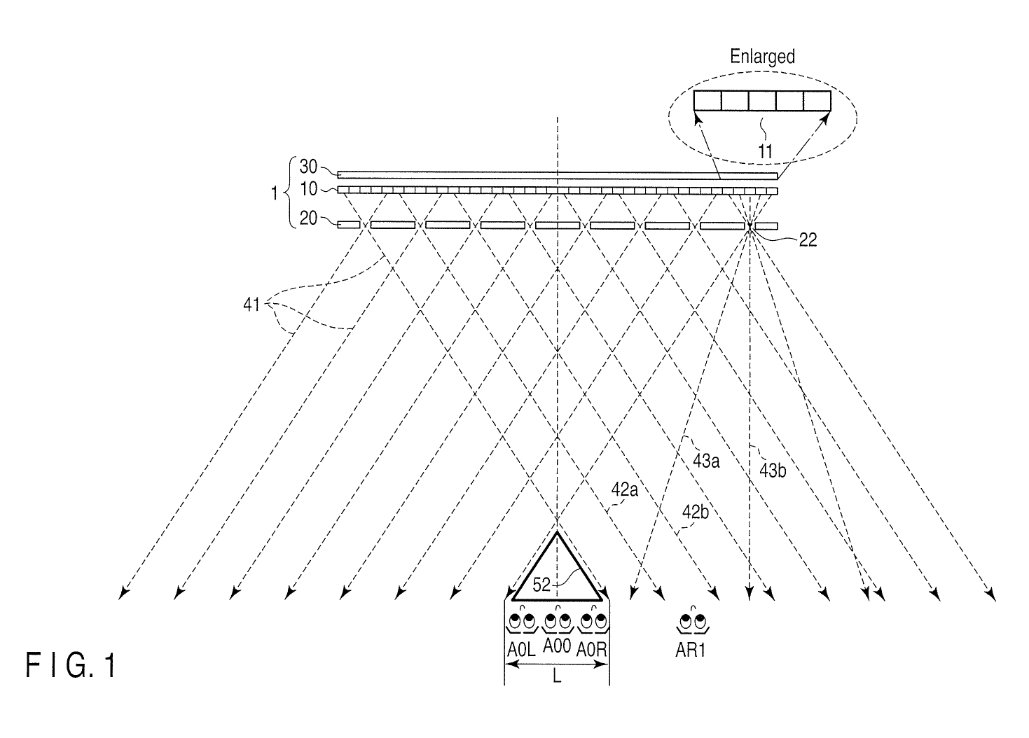

First, the principle of a stereoscopic video display will be described. FIG. 1 is a sectional view schematically showing an example of a stereoscopic video display apparatus according to an embodiment. The embodiment describes an example of stereoscopic vision by the integral method, but the method of stereoscopic vision is not limited to the integral method and any glasses-less type may be used.

A stereoscopic video display apparatus 1 shown in FIG. 1 is of the glasses-less type and includes a display unit 10 including many stereoscopic video display pixels 11 arranged horizontally and vertically and a mask 20 separated from the stereoscopic video display pixels 11 and provided with many window portions 22 corresponding to the stereoscopic video display pixels 11.

The mask 20 includes optical openings and has a function to control rays from the pixels. The mask 20 is also called a parallax barrier or ray control element. A transparent substrate having formed thereon a light-shielding body pattern with many openings corresponding to the many window portions 22 or a light-shielding plate provided with many through-holes corresponding to the many window portions 22 can be used as the mask 20. Alternatively, a fly eye lens in which many micro-lenses are arranged two-dimensionally or a lenticular seat in a shape in which optical openings extend linearly in the vertical direction and are periodically arranged in the horizontal direction can also be used as other examples of the mask 20. Further, a transmission type liquid crystal display unit in which the arrangement, dimensions, shape and the like of the window portion 22 are freely changeable can be used as the mask 20.

For stereoscopic vision of a still image, the stereoscopic video display pixels 11 may be paper on which an image is printed. However, for stereoscopic vision of dynamic images, the stereoscopic video display pixels 11 are realized by using a liquid crystal display unit. Many pixels of the transmission type liquid crystal display unit 10 constitute the many stereoscopic video display pixels 11 and a backlight 30 serving as a surface light source is arranged on the back face side of the liquid crystal display unit 10. The mask 20 is arranged on the front face side of the liquid crystal display unit 10.

When the transmission type liquid crystal display unit 10 is used, the mask 20 may be arranged between the backlight 30 and the liquid crystal display unit 10. Instead of the liquid crystal display unit 10 and the backlight 30, a self-light emitting display apparatus such as an organic EL (electro-luminescence) display apparatus, cathode ray tube, and plasma display apparatus may be used. In such a case, the mask 20 is arranged on the front face side of the self-light emitting display apparatus.

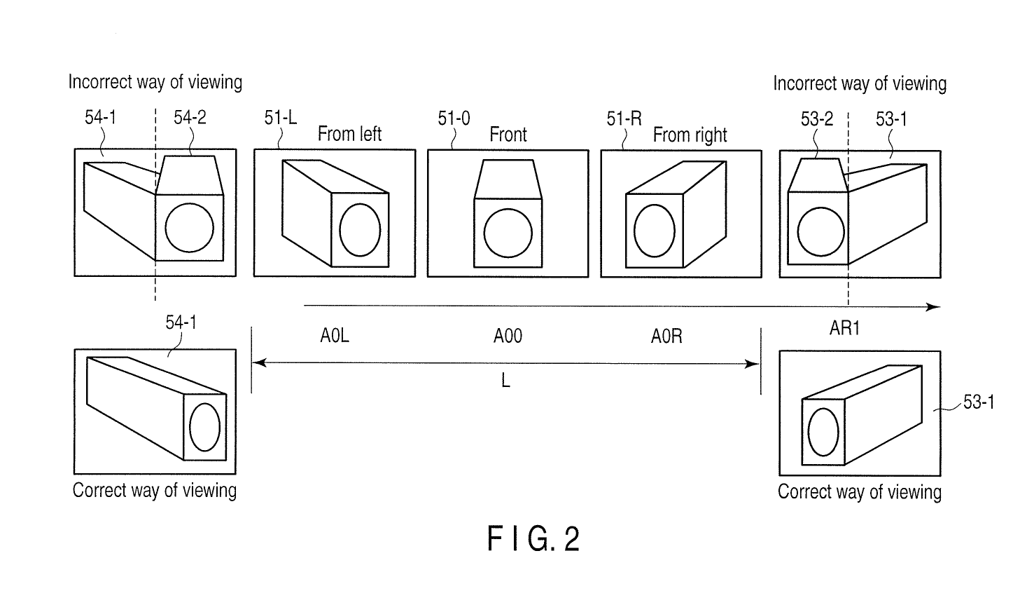

FIG. 1 schematically shows a relationship between the stereoscopic video display apparatus 1 and observation positions A00, A0R, A0L and AR1. The observation position is a position after moving in a horizontal direction of a display screen while maintaining the distance to the screen (or the mask) constant. FIG. 2 is an exemplary view schematically showing stereoscopic video perceived when observed from each of observation positions A00, A0R, A0L, and AR1 shown in FIG. 1.

This example shows an example in which one stereoscopic video display pixel 11 includes a plurality of (for example, five) two-dimensional display pixels. The number of pixels is only an example and may be less than five (for example, two) or more (for example, nine).

In FIG. 1, a broken line 41 is a straight line (ray) linking the center of a single pixel positioned in the boundary between the adjacent stereoscopic video display pixels 11 and the window portion 22 of the mask 20. In FIG. 1, an area of a thick line 52 is an area in which true stereoscopic video (original stereoscopic video) is perceived. The observation positions A00, A0R, and A0L are located within the area of the thick lines 52. In an observation position outside the thick lines 52, for example, in the observation position AR1, false stereoscopic video is perceived. An observation position in which only true stereoscopic video is perceived will be called a “viewing area” below.

Rays emitted from the stereoscopic video display pixel 11 contain not only a ray in a predetermined direction that is originally assumed to pass through only the window portion 22 of the mask 20, but also other undesired rays passing through particularly adjacent window portions. Undesired rays are rays that are not originally needed for true stereoscopic video to be perceived and thus hinder perception of true stereoscopic video and at the same time, the undesired rays cause the viewer to perceive false stereoscopic video that is different from the true stereoscopic video.

False stereoscopic video is similar to the true stereoscopic video, but is normally perceived as a distorted image (defective stereoscopic video) due to reflections of design value shifts. If undesired rays hinder perception of the true stereoscopic video, the true stereoscopic video and false stereoscopic video are perceived as a mixture thereof.

As shown in FIG. 2, normal stereoscopic videos 51-0, 51-L, 51-R are perceived in the observation positions A00, A0R, and A0L. Even when observed within the viewing area, how the true stereoscopic video looks like changes in accordance with the observation position.

Outside the area 52, that is, a position deviating from a range L, for example, in the observation position AR1 to the right, a mixed image of a true stereoscopic video 53-1 and a false stereoscopic video 53-2 is perceived. The ratio of the false stereoscopic video 53-2 contained in the perceived mixed image increases with an increasing distance from the thick line 52.

The depth direction of the false stereoscopic video 53-2 is opposite to the depth direction of the true stereoscopic video 53-1. Stereoscopic video (perceived in the observation position AR1) containing false stereoscopic video is also called an inverse optical image and true stereoscopic video is also called a normal optical image (perceived in the observation positions A00, A0R, A0L).

The above description concerns a case where the observation position is translated in the horizontal direction of a display screen. However, true stereoscopic video and false stereoscopic video similarly change depending on the observation position when the observation position is translated in the vertical direction of the display screen. However, if a lenticular lens or a slit extending in the direction perpendicular to the screen is used as the mask 20, perceived stereoscopic video does not change even if the observation position is changed in the vertical direction. This is because the mask 20 realizes stereoscopic vision by using only a horizontal parallax. If the mask 20 in which fly eye lenses or opening portions are arranged two-dimensionally is used, stereoscopic vision is realized by using parallaxes in both horizontal and vertical directions. If the observation position moves in a distance direction perpendicular to the screen, or the translation and movement in the distance direction are mixed, or the observation position moves on the circumference of a circle around the center of the screen while the distance to the screen is unchanged, true stereoscopic video and false stereoscopic video similarly change depending on the observation position. However, it is difficult for the viewer to distinguish true stereoscopic video from false stereoscopic video.

In a stereoscopic video display apparatus of the glasses-less type, as described above, if the viewer moves to outside a limited viewing area, an inverse optical image (containing false stereoscopic video) will be perceived. That is, the perceived image is different depending on the observation position in a stereoscopic video display apparatus of the glasses-less type. The position where the viewer perceives a normal optical image and the position where the viewer perceives an inverse optical image are inherent depending on the screen size of the display apparatus, the principle of stereoscopic vision and the like.

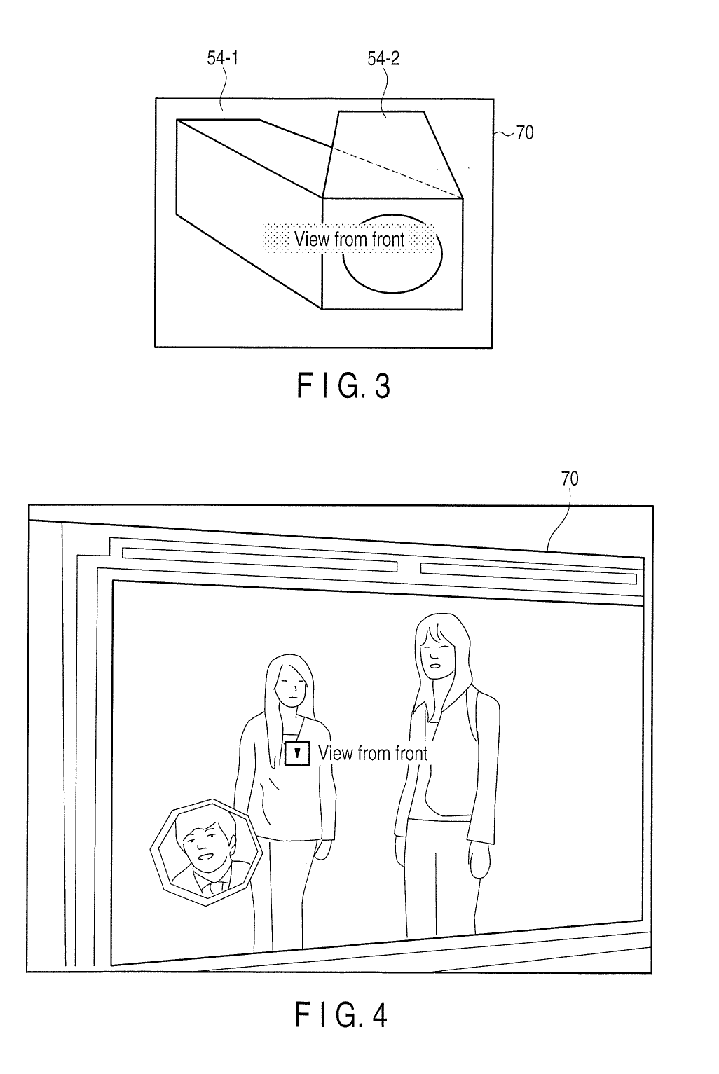

In the present embodiment, that an inverse optical image is perceived in the observation position AR1 is actively used. That is, a message by graphics is multiplexed onto a video signal (for example, the false stereoscopic video 53-2) presenting false stereoscopic video outside the area 52, that is, in an observation position deviating from the range L. Message content is a message like, for example, as shown in FIG. 3, “Please view from the front”. FIG. 4 also shows an example of a screen 70 when the above message is actually displayed. Such a graphic message can be realized by arbitrarily selecting a portion of stereoscopic video display pixels and multiplexing a message graphic signal onto a video signal corresponding to the pixels. For example, a message graphic signal is multiplexed onto a signal supplied to pixels outputting rays 42a, 42b, 43a, and 43b shown in FIG. 1. The message graphic signal need not be limited to this name and may be information signal displaying a figure, character, mark, or symbol indicating that the viewing position of the viewer is different from the predetermined range of the viewing position (the range in which normal stereoscopic video can be perceived).

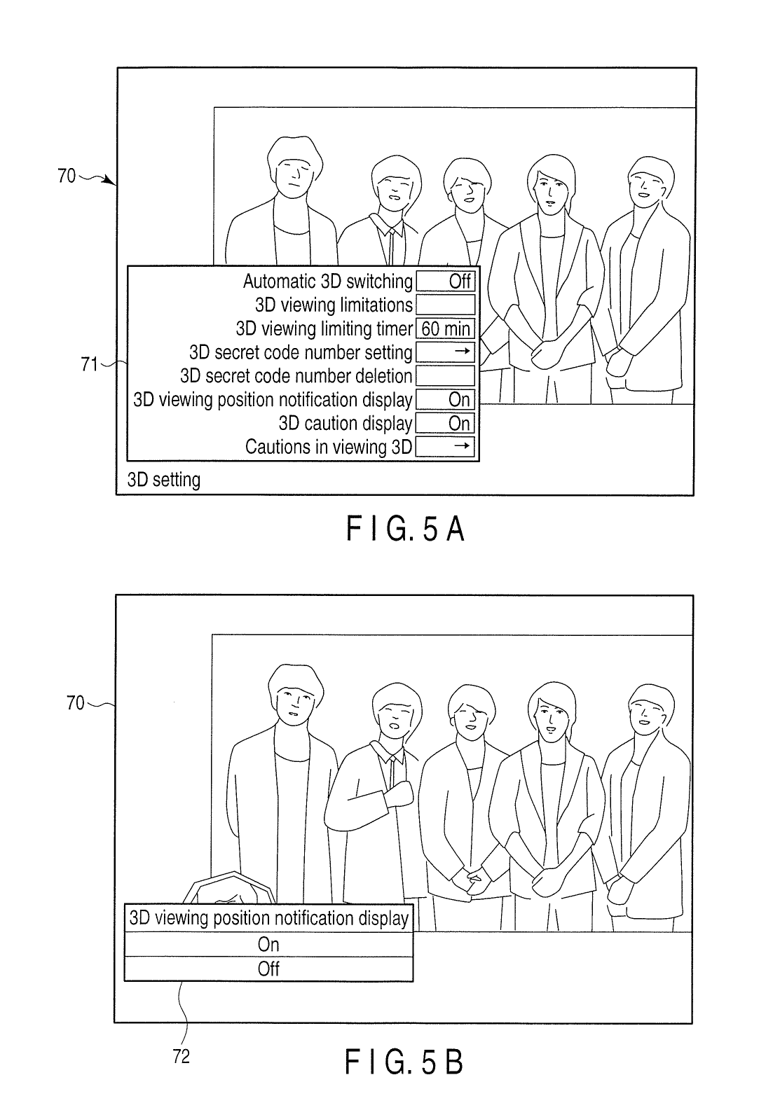

FIGS. 5A and 5B show examples of the screen 70 of stereoscopic video perceived in the predetermined observation position. FIGS. 5A and 5B also show an example of a 3D setting screen 71. That is, a menu screen appears if, for example, a menu button of the remote controller is pressed and the 3D setting screen 71 is displayed if the cursor is moved onto the item “3D setting” in the menu screen and the Decision button is pressed. The 3D setting screen 71 contains an item called “3D viewing position notification display” and, as shown in FIG. 5B, a selection screen 72 to select to turn on or off the display of the 3D viewing position (or the current 3D position) is displayed if the cursor is moved onto the item and the Decision button is pressed. If the cursor is moved onto the item “On” and the Decision button is pressed, the display as shown in FIG. 4 can be obtained when an inverse optical image is perceived. The term “3D viewing position” is not limited and may also be called a “current 3D position” or “3D observation position”, or simply a “current position” or an “observation position”.

The 3D viewing position notification display can, as described above, call attention to the fact that if the user who uses a glasses-less stereoscopic video display apparatus for the first time views from an incorrect direction, stereoscopic (3D) video is not correctly viewable.

However, the user can determine whether the user is viewing from the correct angle based on the stereoscopic (3D) video being viewed as the user becomes familiar therewith and the 3D viewing position notification display could become rather an obstacle.

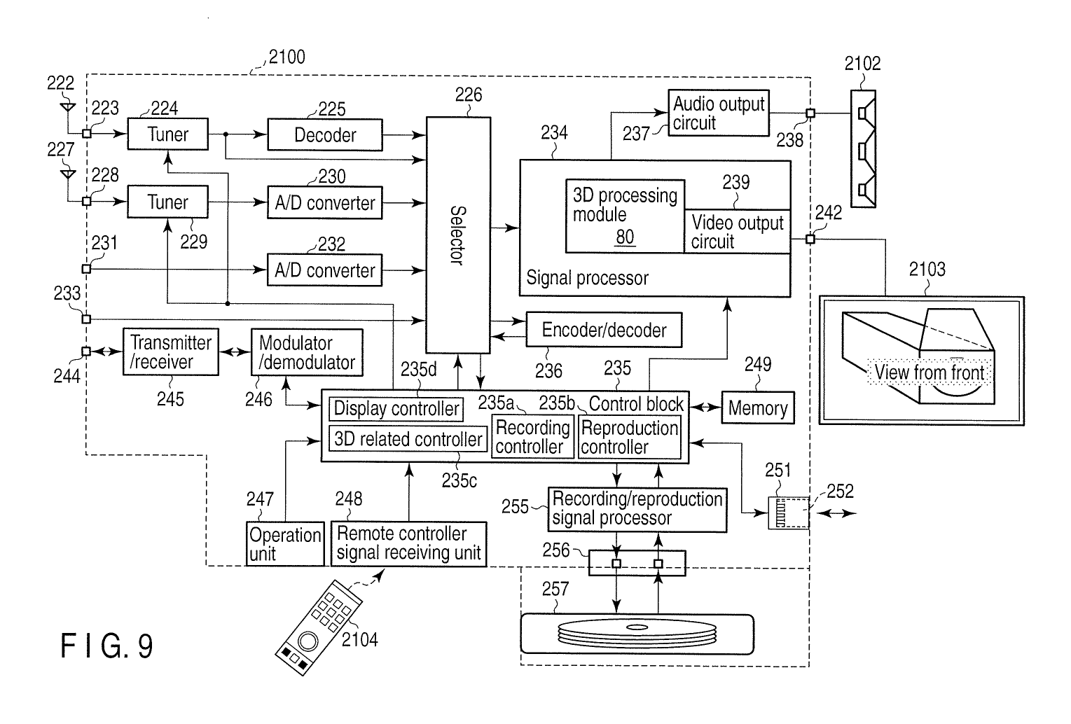

Thus, the user is enabled to set whether to make a 3D viewing position notification display by newly providing a setting screen that can turn “on” or “off” the 3D viewing position notification display. The initial value is set to “off”. There is no need to display the message in 2D and thus, when the display is switched to the 2D display, no message is displayed even if “on” is set. For this purpose, when the 3D related controller (shown in FIG. 9) (including a 3D/2D output detection module and a message output on/off switching module) capable of determining whether the apparatus is in 2D mode or 3D mode determines that the apparatus is in 2D mode, information about the 3D viewing position notification is not multiplexed onto a video signal. The module can of course turn “on” or “off” the 3D viewing position notification display in accordance with operation input during 3D viewing and the user can check the display status of the 3D viewing position notification display while viewing 3D video.

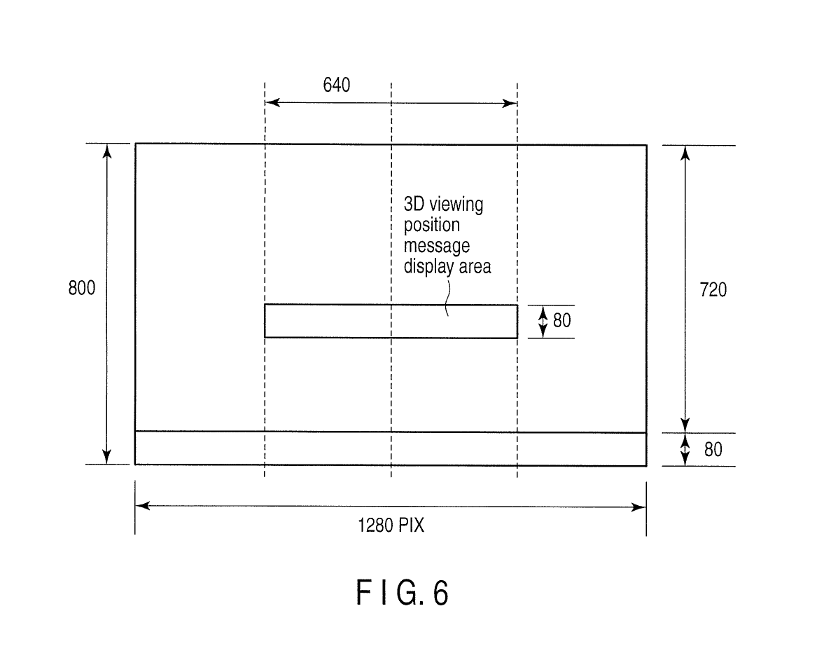

FIG. 6 shows an example of the display position of a 3D viewing position notification message. It is assumed, for example, that the screen of one frame has 800 lines and 1280 pixels. It is also assumed in this example that a mask portion of 80 lines is secured in the lower part of the screen. The mask portion may be divided and arranged in an upper part and a lower part of the screen. In such a screen (display area), the 3D viewing position notification message area is effective when, for example, the width thereof is about 640 pixels±20 pixels and the width in the vertical direction is about 80 lines±10 lines in the center in the left/right direction of the screen. The 3D viewing position notification message display is made in the center of the screen. In terms of the ratio of the message area to the screen, improvement of visibility is achieved if the message area is about (½)±( 1/64) of the main video screen in the horizontal direction and in the center position in the left-right direction and about ( 1/9)±( 1/72) of the display area in the vertical direction without regard to the vertical position. If the 3D viewing position notification display is made in the center position in the horizontal direction of the screen as described above, the 3D viewing position notification display does not mix with normal stereoscopic video when the screen is viewed from the front.

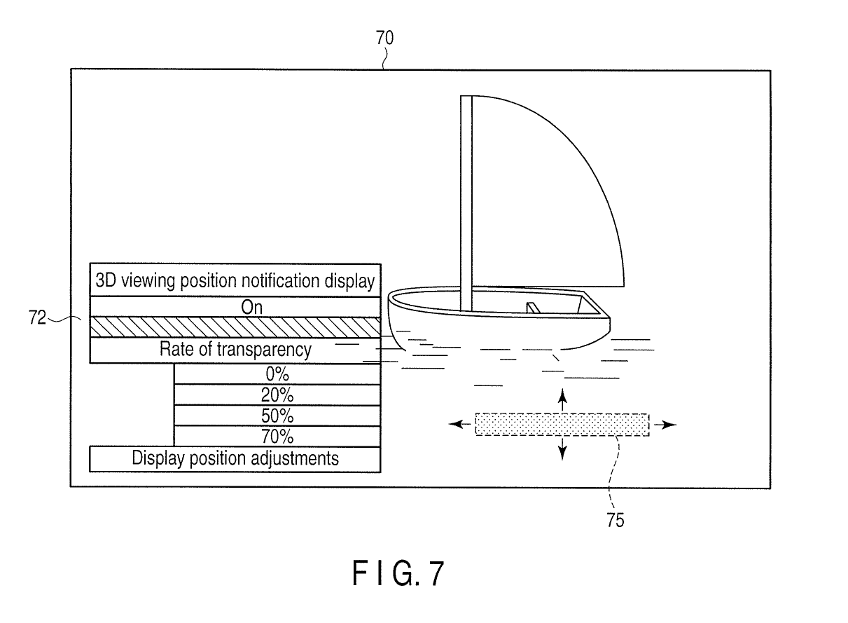

Further, the 3D related controller (shown in FIG. 9) can make the 3D viewing position notification display transparent in accordance with an operation or setting so that the message display should not be an obstacle to video being viewed. The user can set transparency. Further in this case, the display position of a 3D viewing position notification can be changed. In the present embodiment, as shown in FIG. 7, an item to set the transparency appears in the menu screen. The user can set the transparency of the 3D viewing position notification display by moving the cursor to the position of the desired setting item (such as the transparency of 0%, 20%, 50%, and 70%) through a remote controller operation and pressing the Decision button. At this point, a sample image 75 of the 3D viewing position notification display to show the level of transparency may be displayed. If the user moves the cursor to an item of “Position adjustment” through a remote controller operation and presses the Decision button, the 3D viewing position notification display position becomes adjustable. If the Decision button is pressed, the sample image 75 starts to flash so that the sample image 75 can be moved to a desired position in the screen by a cursor move button. If the user presses the Decision button after moving the sample image 75 to a desired position (up and down, left and right) in the screen, the moved position is decided as the display position of the 3D viewing position notification in the future and the sample image 75 is erased.

The width of the 3D viewing position notification display can also be changed. In this case, if the user further scrolls the menu screen, a “Width change of 3D viewing position notification display” item appears. If the “Width change of 3D viewing position notification display” item is selected and the Decision button is pressed, the sample image 75 is displayed and a guide message to change the width is displayed. The user can adjust the width by moving the cursor to an edge of the sample image 75 and operating an arrow button of the remote controller. If the width of the sample image 75 is adjusted to a desired width and the Decision button is pressed, the width is decided and the sample image 75 is erased.

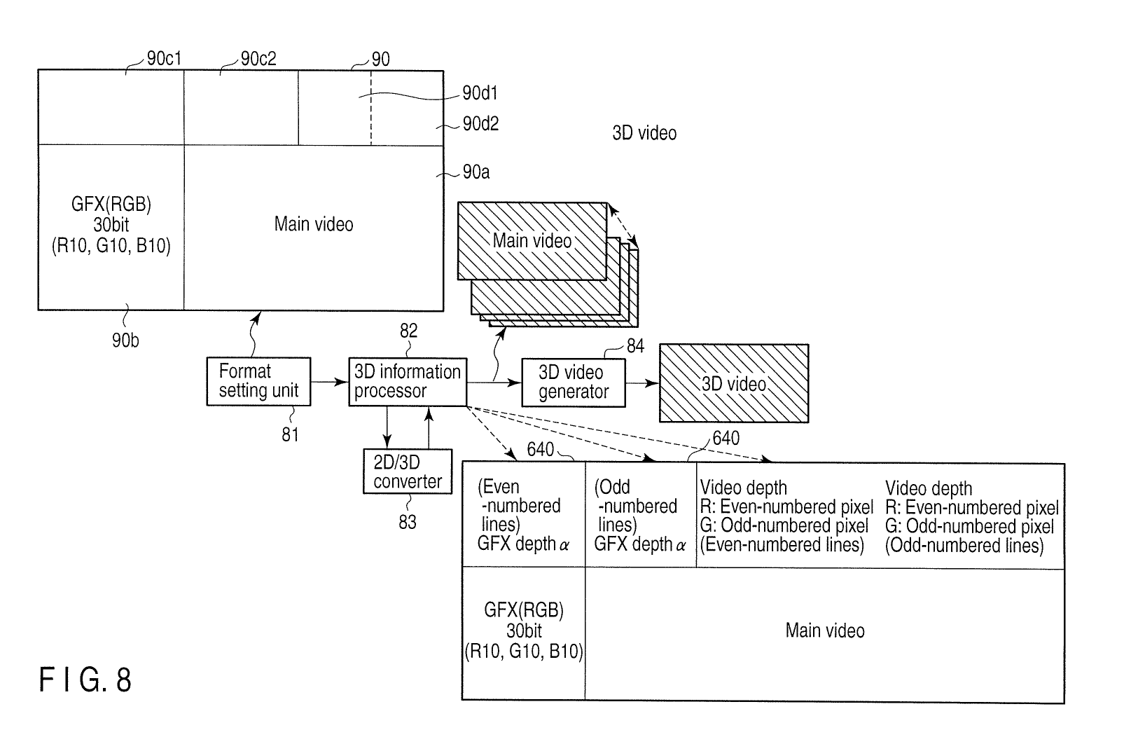

FIG. 8 shows an example of the 3D processing module 80 that performs the above processing. The 3D processing module 80 includes, for example, a format setting unit 81 that forms a high-resolution 2D digital input video signal into a 3D signal format. If a 3D signal is input, the 3D signal can be adopted unchanged.

After being 3D-formatted by a format setting unit 81, the 2D digital input video signal is input into a 3D information processor 82. The 3D information processor 82 extracts main video data and sends the extracted video data to a 2D/3D converter 83. The 2D/3D converter 83 generates depth information (this information, which may also be called length information, is assumed to contain parallax information) for each pixel of the main video data. The 3D information processor 82 uses information of the 3D signal format generated by the format setting unit 81 and the depth information of the main video data generated by the 2D/3D converter 83 to generate a plurality of (for example, nine) video planes for 3D configuration. The depth information for each pixel of graphic data may be preset to the format setting unit 81.

The plurality of video planes for 3D configuration and the depth information are input into a 3D video generator 84 for conversion into a 3D video display signal (stereoscopic video display signal). The 3D video display signal becomes a pattern signal that drives stereoscopic video display pixels shown in FIG. 8.

The 3D signal format includes an area 90a to arrange main video data, an area 90b to arrange graphic data (including R, G, and B pixels), an area 90c1 to arrange depth information of pixels of even-numbered lines of the graphic data and an α value, an area 90c2 to arrange depth information of pixels of odd-numbered lines of the graphic data, an area 90d1 to arrange depth information of pixels of even-numbered lines of the main video data and the α value, and an area 90d2 to arrange depth information of pixels of odd-numbered lines of the main video data. Depth information of pixels of the main video data contains depth information about even-numbered pixels and odd-numbered pixels. The α value is a value indicating the degree of overlapping with pixels of graphic data.

The area 90a of main video data has, for example, 1280 pixels×720 lines, the area 90b has 640 pixels×720 lines, the area 90c1 has 640 pixels×360 lines, the area 90c2 has 640 pixels×360 lines, the area 90d1 has 320 pixels×360 lines, and the area 90d2 has 320 pixels×360 lines.

The other areas 90c1, 90c2, 90d1, 90d2 than the areas 90a, 90b of main video data and graphic data may be called control information areas. Control information is generated by the 3D information processor 82 and the 2D/3D converter 83 and arranged in predetermined areas.

FIG. 9 schematically shows a signal processing system of the TV set 2100, which is an example of an apparatus to which the embodiment is applied. A digital TV broadcasting signal received by an antenna 222 for receiving digital TV broadcasting is supplied to a tuner 224 via an input terminal 223. The tuner 224 tunes in to and demodulates a signal of the desired channel from the input digital TV broadcasting signal. A signal output from the tuner 224 is supplied to a decoder 225 where decode processing according to, for example, the MPEG (moving picture experts group) 2 method is performed before being supplied to a selector 226.

Output from the tuner 224 is also supplied to the selector 226 directly. Video/audio information is separated by the selector 226 so that the video/audio information can be processed by a recording/reproduction signal processor 255 via a control block 235. A signal processed by the recording/reproduction signal processor 255 can be recorded in a hard disk drive (HDD) 257. The HDD 257 is connected as a unit to the recording/reproduction signal processor 255 via a terminal 256 and can be replaced. The HDD 257 contains a recorder and a reader of a signal.

An analog TV broadcasting signal received by an antenna 227 for analog TV broadcasting is supplied to a tuner 229 via an input terminal 228. The tuner 229 tunes in to and demodulates a signal of the desired channel from the input analog TV broadcasting signal. Then, a signal output from the tuner 229 is digitized by an A/D (analog/digital) converter 230 before being output to the selector 226.

Analog video and audio signals supplied to an input terminal 231 for an analog signal to which, for example, devices such as a VTR are connected are supplied to an A/D converter 232 for digitalization and then output to the selector 226. Further, digital video and audio signals supplied to an input terminal 233 for a digital signal connected to an external device such as an optical disk or magnetic recording medium reproduction apparatus via, for example, HDMI (High Definition Multimedia Interface) are supplied to the selector 226 unchanged.

When an A/D converted signal is recorded in the HDD 257, compression processing based on a predetermined format, for example, the MPEG (moving picture experts group) 2 method is performed on the A/D converted signal by an encoder in an encoder/decoder 236 accompanying the selector 226 before the A/D converted signal is recorded in the HDD 257 via the recording/reproduction signal processor 255. When the recording/reproduction signal processor 255 records information in the HDD 257 in cooperation with a recording controller 235a, for example, what kind of information to record in which directory of the HDD 257 is pre-programmed. Thus, conditions when a stream file is stored in a stream directory and conditions when identification information is stored in a recording list file are set.

The selector 226 selects one pair from four types of input digital video and audio signals to supply the pair to a signal processor 234. The signal processor 234 separates audio information and video information from the input digital video signal and performs predetermined signal processing thereon. Audio decoding, tone adjustment, mix processing and the like are arbitrarily performed as the signal processing on the audio information. Color/brightness separation processing, color adjustment processing, image quality adjustment processing and the like are performed on the video information.

The 3D processing module 80 described above is contained in the signal processor 234. A video output unit 239 switches to 3D signal output or 2D signal output in accordance with 3D/2D switching. The video output unit 239 includes a synthesis unit that multiplexes graphic video, video of characters, figures, symbols and the like, user interface video, video of a program guide and the like from the control block 235 onto main video. The video output unit 239 may contain a scanning line number conversion.

Audio information is converted into an analog form by an audio output circuit 237 and the volume, channel balance and the like thereof are adjusted before being output to a speaker apparatus 2102 via an output terminal 238.

Video information undergoes synthesis processing of pixels, the scanning line number conversion and the like in the video output unit 239 before being output to a display apparatus 2103 via an output terminal 242. As the display apparatus 2103, for example, the apparatus described in FIG. 1 is adopted.

Various kinds of operations including various receiving operations of the TV set 2100 are controlled by the control block 235 in a unified manner. The control block 235 is a set of microprocessors incorporating CPUs (central processing units). The control block 235 controls each of various blocks so that operation information from an operation unit 247 or operation information transmitted from a remote controller 2104 is acquired by a remote controller signal receiving unit 248 whereby operation content thereof is reflected.

The control block 235 uses a memory 249. The memory 249 mainly includes a ROM (read only memory) storing a control program executed by a CPU thereof, a RAM (random access memory) to provide a work area to the CPU, a nonvolatile memory in which various kinds of setting information and control information are stored.

The apparatus can perform communication with an external server via the Internet. A downstream signal from a connection terminal 244 is demodulated by transmitter/receiver 245 and demodulated by a modulator/demodulator 246 before being input into the control block 235. An upstream signal is modulated by the modulator/demodulator 246 and converted into a transmission signal by the transmitter/receiver 245 before being output to the connection terminal 244.

The control block 235 can perform conversion processing on dynamic images or service information downloaded from an external server to supply the converted images or information to the video output unit 239. The control block 235 can also transmit a service request signal to an external server in response to a remote controller operation.

Further, the control block 235 can read data in a card type memory 252 mounted on a connector 251. Thus, the present apparatus can read, for example, photo image data from the card type memory 252 to display the photo image data in the display apparatus 2103. When special color adjustments are made, image data from the card type memory 252 can be used as standard data or reference data.

In the above apparatus, a user views a desired program of a digital TV broadcasting signal and also selects a program by operating the remote controller 2104 to control the tuner 224 if the user wants to save the program in the HDD 257.

Output of the tuner 224 is decoded by the decoder 225 into a base-band video signal and the base-band video signal is input into the signal processor 234 from the selector 226. Accordingly, the user can view the desired program in the display apparatus 2103.

A stream (including many packets) of the selected program is input into the control block 235 via the selector 226. If the user performs a recording operation, the recording controller 235a selects the stream of the program and supplies the stream to the recording/reproduction signal processor 255. For example, a file number is attached to the stream of the selected program and the stream is stored in a file directory of the HDD 257 as a stream file by the operations of the recording controller 235a and the recording/reproduction signal processor 255.

If the user wants to reproduce and view the stream file recorded in the HDD 257, the user operates, for example, the remote controller 2104 to specify the display of, for example, a recording list file.

The recording list file has a table of a file number and a file name (called identification information) indicating what kinds of stream files are recorded in the HDD 257. If the user specifies the display of the recording list file, a recording list is displayed as a menu and the user moves the cursor to a desired program name or file number in the displayed list before operating the Decision button. Then, the reproduction of the desired stream file is started.

The specified stream file is read from the HDD 257 under the control of a reproduction controller 235b and decoded by the recording/reproduction signal processor 255 before being input into the signal processor 234 via the control block 235 and the selector 226.

The control block 235 includes a recording controller 235a, a reproduction controller 235b, and a 3D related controller 235c.

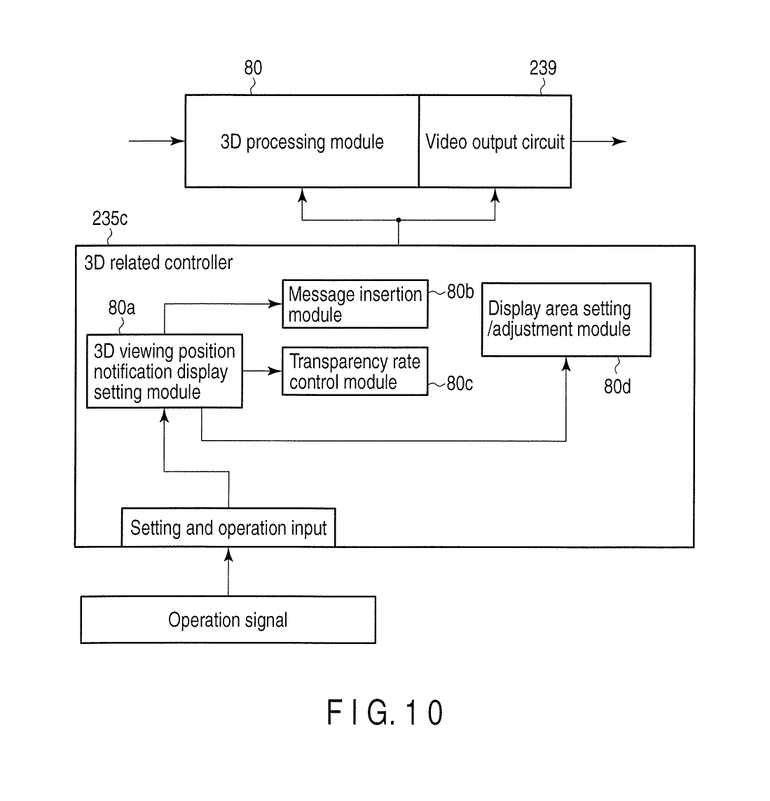

FIG. 10 picks up and shows the 3D related controller 235c, the 3D processing module 80, and the video output circuit 239.

As described in FIGS. 5A and 5B, the 3D related controller 235c can set whether to make a 3D viewing position notification display. This setting is carried out by a message insertion module 80b being controlled by a 3D viewing position notification display setting module 80a in accordance with an operation signal. The 3D viewing position notification display position (described in FIG. 6) is set by a display area setting/adjustment module 80d. The display area setting/adjustment module 80d can move the 3D viewing position notification display position vertically in accordance with an operation signal. Further, a transparency control module 80c can adjust the transparency of 3D viewing position notification video in accordance with an operation signal or initialize the transparency.

In the above description, the name “false stereoscopic video” is used because the name is a convenient expression in the embodiment. However, the present invention can be carried out and applied in various ways. Basically, the concept of the invention is to actively use an inverse optical image being perceived. Therefore, “false stereoscopic video” may also be called “deformed stereoscopic video”, “sub-stereoscopic video”, or “inverse stereoscopic video”.

In the above embodiments, the module is used as a name of some blocks. However, the module is not limited in the scope of the invention. It may be used block, unit, processor, circuit and combination of these terms instead of the module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic video display apparatus of a glasses-less type that displays video perceived as original stereoscopic video when observed within a predetermined range of a viewing position and perceived as defective stereoscopic video when observed from a position different from the predetermined range of the viewing position, comprising:
a 3D related controller configured to insert an information signal displaying a figure, a character, a mark, or a symbol indicating that the viewing position is different from the predetermined range of the viewing position into a signal of the defective stereoscopic video.

2. The stereoscopic video display apparatus of claim 1, wherein the 3D related controller includes a unit to set an area of display video of the information signal to a horizontal width of about (½)±( 1/64) of the width of a main video signal in a horizontal direction.

3. The stereoscopic video display apparatus of claim 2, wherein the 3D related controller includes a unit to turn on or off the display video of the information signal.

4. The stereoscopic video display apparatus of claim 3, wherein the 3D related controller includes a unit to control transparency with respect to the display video of the information signal in accordance with operation input.

5. The stereoscopic video display apparatus of claim 3, wherein the 3D related controller includes a unit to vertically move the display video of the information signal in accordance with operation input.

6. The stereoscopic video display apparatus of claim 1, wherein the defective stereoscopic video is an inverse stereoscopic video and the information signal is a character string specifying the viewing position.

7. A stereoscopic video display method of a glasses-less type that displays video perceived as original stereoscopic video when observed within a predetermined range of a viewing position and perceived as defective stereoscopic video when observed from a position different from the predetermined range of the viewing position, comprising:
inserting an information signal displaying a figure, a character, a mark, or a symbol indicating that the viewing position is different from the predetermined range of the viewing position into a signal of the defective stereoscopic video.

8. The stereoscopic video display method of claim 7, wherein an area of display video of the information signal is set to a horizontal width of about (½)±( 1/64) of the width of a main video signal in a horizontal direction.

9. The stereoscopic video display method of claim 8, wherein the display video of the information signal is turned on or off in accordance with operation input.

10. The stereoscopic video display method of claim 8, wherein transparency for the display video of the information signal is controlled and/or display video of the information signal is moved vertically in a screen in accordance with operation input.
